(19) United States
(12) Patent Application Publication
(10) Pub. No.: US 2009/0112692 A1
(43) Pub. Date: Apr. 30, 2009

(54) Engine, system and method for generation of brand affinity content

(76) Inventors: Ryan Steelberg, Irvine, CA (US); Chad Steelberg, Newport Beach, CA (US)

Correspondence Address: GIBBONS P.C., ONE GATEWAY CENTER, NEWARK, NJ, 07102, US

(21) Appl. No.: 11/981,646

(22) Filed: Oct. 31, 2007

(51) Int. Cl. G06Q 10/00; G06Q 30/00; G06F 3/048

(52) U.S. Cl. 705/10; 705/14; 715/709

(57) ABSTRACT

An endorsed advertising engine, system and method, which includes at least one vault having media assets, a recommendation engine that matches the media assets from the vault with at least one requested creative, and a delivery engine that integrates the requested creative with the matched media assets from the vault.

### BACKGROUND OF THE INVENTION

1. Field of the Invention

The present invention is directed to an advertising engine and, more particularly, to an engine for generation of brand affinity content, and a method of making and using same.

The present invention is related to concurrently filed U.S. patent application Ser. No. ______, entitled “AN ADVERTISING REQUEST AND RULES-BASED CONTENT PROVISION ENGINE, SYSTEM AND METHOD” filed Oct. 31, 2007, the entire contents of which are incorporated herein by reference.

### DESCRIPTION OF THE BACKGROUND

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Factors that will increase the impact of an endorser include the endorser's perceived knowledge of particular goods or in a particular industry, the fame or popularity of the endorser, the respect typically accorded a particular endorser or sponsor, and other similar factors.

Consequently, the highest impact advertising time or block available for sale will generally be time that is associated, such as both within the advertisement and within the program with which the advertisement is associated, with an endorser most likely to have high impact on the ideal target customer. However, the existing art makes little use of this advertising reality.

Thus, there exists a need for an engine, system and method that allows for the obtaining of an endorsement or sponsorship, in the aforementioned high-impact circumstances, either from a specific individual, a specific entity, an affinity brand, a marketing partner, or a sponsor.

### SUMMARY OF THE INVENTION

The present invention includes at least an endorsed advertising engine, system and method, which includes at least one vault having media assets, a recommendation engine that matches the media assets from the vault with at least one requested creative, and a delivery engine that integrates the requested creative with the matched media assets from the vault.

Thus, the present invention provides an engine, system and method that allows for the obtaining of an endorsement or sponsorship, in the aforementioned high-impact circumstances, either from a specific individual, a specific entity, an affinity brand, a marketing partner, or a sponsor.

### BRIEF DESCRIPTION OF THE FIGURES

The present invention will be described hereinbelow in conjunction with the following figures, in which like numerals represent like items, and wherein:

FIG. 1 illustrates an exemplary embodiment of the present invention.

### DETAILED DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical advertising engines, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

It is generally accepted that advertising (hereinafter also referred to as “ad” or “creative”) having the highest impact on the desired consumer base includes endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will be used in connection with an audio visual work that has an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on the use of endorsements in particular industries, wherein a different product or a different industry may be endorsed (such as in a different geographical area) by the same endorser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

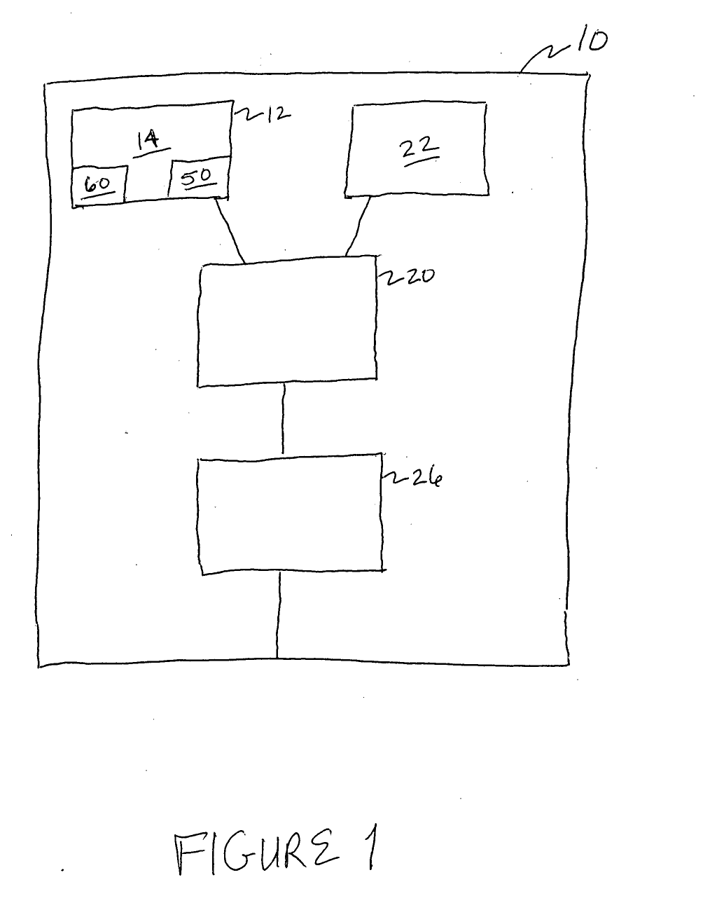

At present, there is a need for a platform or engine to allow for the obtaining of an endorsement, or endorsed ad, in any of the above circumstances, either from a specific individual, a specific entity, an affinity brand, a marketing partner, or a sponsor. In the present invention, an endorsed advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with an creative/ad 22, and a delivery engine 26 capable of integrating a requested ad 22 with the media asset 14 from the vault 12, late stage binding of the ad 22 and media asset 16 upon delivery to strongest target consumers, and delivery of the ad 22 and the dynamic media asset 16 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as in the event that later stage tracking can further improve ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Because the bids for advertising time in the present invention may vary as discussed above, the present invention lends itself to auction-style placement of advertising, in which bids are solicited for particular locations, times, or blocks of advertising. Auctions may be held, for example, on line, and may be broken down by media outlet type of ad (i.e. television, internet, etc.), product type of ad, or in any similar manner.

As will be apparent to those skilled in the art, the engines within the endorsed advertising engine of the present invention may draw on any number of communication access points and media sources, including wired and wireless, radio and cable, telephone, television and internet, personal electronic devices, satellite, databases, data files, and the like, in order to increase content in the vault, contribute content for intelligent selection of brand associations, and best allow for recommendations and delivery.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

1. An endorsed advertising engine, comprising:
at least one vault comprising media assets;
a recommendation engine that matches the media assets from the vault with at least one requested creative; and
a delivery engine that integrates the requested creative with the matched media assets from the vault.

2. The endorsed advertising engine of claim 1, wherein the integration by the delivery engine comprises a late stage binding.

3. The endorsed advertising engine of claim 1, wherein the integration by the delivery engine comprises a separate delivery of the requested creative and the matched media assets for mash up by a third part advertising server.

4. The endorsed advertising engine of claim 1, further comprising an advertising wizard for creation of the requested creative.

5. The endorsed advertising engine of claim 4, wherein the advertising wizard comprises a plurality of blank advertising templates.

6. The endorsed advertising engine of claim 1, wherein the media assets comprise brands other than a brand of the requested creative.

7. The endorsed advertising engine of claim 1, wherein the media assets comprise at least two of statistics, video, pictures, sound bites, symbols, emblems, taglines, press releases, publications, avatars, animations, and web links.

8. The endorsed advertising engine of claim 1, wherein the media assets comprise assets capable of being re-purposed.

9. The endorsed advertising engine of claim 1, wherein the media assets associate with exclusions, inclusions, and preferences of a subject of the media assets.

10. The endorsed advertising engine of claim 9, wherein the exclusions comprise at least one of geographic limitations, product limitations, preferred partners, preferred product types, time, date, relationship with other assets, relationship with other media types and conflicts with a pre-existing endorsements.

11. The endorsed advertising engine of claim 1, wherein the media assets associate with payment schema.

12. The endorsed advertising engine of claim 11, wherein the payment schema vary based on a requester of the requested creative, the requested creative, a delivered asset, and a consumer of the requested creative.

13. The endorsed advertising engine of claim 1, wherein the recommendation engine engages in recommending assets based on exclusions of the media assets, and at least one of secondary information external to the vault and variable factoring.

14. The endorsed advertising engine of claim 13, wherein the variable factoring comprises a brand association between the media asset's brand and a brand of the requested creative.

15. The endorsed advertising engine of claim 1, wherein each media asset comprises a profile of that media asset.

16. The endorsed advertising engine of claim 15, wherein each of the profiles comprises at least a psychological profile of typical users of that media asset's brand, target customers of that media asset's brand, and target affiliate profiles.

17. The endorsed advertising engine of claim 16, wherein the target affiliate profile comprises at least two of desired sharing of marketing costs, desired increasing brand recognition in certain geographies, desired increasing brand recognition in certain fields of use, distribution channel access, expedited market entry, and improved brand perception.

18. The endorsed advertising engine of claim 1, wherein at least two of the matches are presented for selection of one of the matches.

19. The endorsed advertising engine of claim 1, wherein at least one bid for the requested creative is variable in accordance with a quality of the match.

20. An endorsed advertising engine, comprising:
at least one vault comprising media assets;
a recommendation engine that matches the media assets from the vault with at least one asset backed media; and
a delivery engine that integrates the asset backed media with the matched media assets from the vault.

21. The endorsed advertising engine of claim 20, wherein the integration by the delivery engine comprises a late stage binding.

22. The endorsed advertising engine of claim 20, wherein the integration by the delivery engine comprises a pre-binding.

23. The endorsed advertising engine of claim 20, wherein the integration by the delivery engine comprises keyword request matching.

24. The endorsed advertising engine of claim 20, wherein the integration by the delivery engine comprises delivery based on a query.

25. The endorsed advertising engine of claim 20, wherein the asset backed media is at least a portion of an advertising request.

26. The endorsed advertising engine of claim 20, wherein the integration by the delivery engine comprises dynamic content on a sponsoring page.

27. The endorsed advertising engine of claim 20, wherein the integration by the delivery engine comprises a separate delivery of the asset backed media and the matched media assets for mash up by a third part advertising server.

28. The endorsed advertising engine of claim 20, further comprising an advertising wizard for creation of the asset backed media.

29. The endorsed advertising engine of claim 28, wherein the advertising wizard comprises a plurality of blank advertising templates.

30. The endorsed advertising engine of claim 20, wherein the media assets comprise brands other than a brand of the asset backed media

31. The endorsed advertising engine of claim 20, wherein the media assets comprise at least two of statistics, video, pictures, sound bites, symbols, emblems, taglines, press releases, publications, avatars, animations and web links.

32. The endorsed advertising engine of claim 20, wherein the media assets comprise assets capable of being re-purposed.

33. The endorsed advertising engine of claim 20, wherein the media assets are associated with exclusions, inclusions, and preferences of a subject of the media assets.

34. The endorsed advertising engine of claim 33, wherein the exclusions comprise at least one of geographic limitations, product limitations, preferred partners, preferred product types, time, date, relationship with other assets, relationship with other media types and conflicts with a pre-existing endorsements.

35. The endorsed advertising engine of claim 20, wherein the media assets associate with payment schema.

36. The endorsed advertising engine of claim 35, wherein the payment schema vary based on at least one of the requester of the asset backed media, the asset backed media, a delivered asset, and a consumer of the asset backed media.

37. The endorsed advertising engine of claim 20, wherein the recommendation engine engages in recommending assets based on exclusions of the media assets, and at least one of secondary information external to the vault and variable factoring.

38. The endorsed advertising engine of claim 37, wherein the variable factoring comprises a brand association between the media asset's brand and a brand of the requested creative.

39. The endorsed advertising engine of claim 20, wherein each media asset comprises a profile of that media asset.

40. The endorsed advertising engine of claim 39, wherein each of the profiles comprises at least a psychological profile of typical users of that media asset's brand target customers of that media asset's brand, and target affiliate profiles.

41. The endorsed advertising engine of claim 40, wherein the target affiliate profile comprises at least two of desired sharing of marketing costs, desired increasing brand recognition in certain geographies, desired increasing brand recognition in certain fields of use, distribution channel access, expedited market entry, and improved brand perception.

42. The endorsed advertising engine of claim 20, wherein at least two of the matches are presented for selection of one of the matches.

43. The endorsed advertising engine of claim 20, wherein at least one bid for the asset backed media is variable in accordance with a quality of the match.
